(19) United States
(12) Patent Application Publication
(10) Pub. No.: US 2024/0220611 A1
(43) Pub. Date: Jul. 4, 2024

(54) EXTRACTING DEVICE, EXTRACTING METHOD, AND EXTRACTING PROGRAM

(71) Applicant: NIPPON TELEGRAPH AND TELEPHONE CORPORATION, Tokyo (JP)

(72) Inventors: Yuki OCHI, Tokyo (JP); Yusuke HISADA, Tokyo (JP)

(73) Assignee: NIPPON TELEGRAPH AND TELEPHONE CORPORATION, Tokyo (JP)

(21) Appl. No.: 18/558,361

(22) PCT Filed: May 12, 2021
(86) PCT No.: PCT/JP2021/018049

§ 371 Date: Oct. 31, 2023

(51) Int. Cl. G06F 21/55

(52) U.S. Cl. CPC G06F 21/552

(57) ABSTRACT

An extraction device (10) collects a log of a computer to be investigated. Furthermore, the extraction device (10) extracts a log group matching any signature from the collected data with reference to a rule which lists a plurality of signatures which indicate an attack on the computer arranged in an order which is characteristic of the attack. Subsequently, the extraction device (10) extracts a log group in which the longest common subsequence between the time-series sequence of signatures which match logs in the extracted log group and the sequence of signatures indicated in the rule is the longest. After that, the extraction device (10) calculates, for each of the log groups in which the longest common subsequence with the sequence of signatures indicated in the rule is the longest, the variance value of the time differences between the logs which are adjacent in time series in the log group. Furthermore, the extraction device (10) outputs the longest common subsequence in the log group having the smallest variance value among the extracted log group as a candidate for the trace of the attack.

### TECHNICAL FIELD

The present invention relates to an extraction device, an extraction method, and an extraction program for extracting a log showing a trace of an attack.

### BACKGROUND ART

In recent years, in computer forensics investigations, signatures indicating characteristics of attacks have been used for extracting logs indicating traces of attacks from personal computer (PC) logs (refer to NPL 1).

### CITATION LIST

### Non Patent Literature

[NPL 1] Sigma-Generic Signatures for SIEM Systems, [retrieved on Apr. 22, 2021], Internet <URL: https://www.slideshare.net/secret/gvgxexoKb1XRcA>

### SUMMARY OF INVENTION

### Technical Problem

However, a method in the related art of extracting a log indicating a trace of an attack using a signature may include extracting a log which is output through a normal operation other than the attack. Therefore, an object of the present invention is to solve the above-described problem and to accurately extract a trace of an attack.

### Solution to Problem

In order to solve the above problem, the present invention includes: a log collection unit configured to collect a log of a computer to be investigated; a first extraction unit configured to extract a log group which matches any signature indicated by a rule from the collected logs with reference to the rule which lists a plurality of signatures which indicate an attack on the computer arranged in an order which is characteristic of the attack; a second extraction unit configured to extract a log group in which a longest common subsequence between a chronological sequence of signatures which match logs in the extracted log group and a sequence of a plurality of signatures indicated in the rule is the longest; a calculation unit configured to calculate, for each log group in which the longest common subsequence is the longest, a variance value of a time difference between each log which is adjacent in time series in the log group; and an output processing unit configured to output the longest common subsequence in the log group with a minimum calculated variance value as an attack trace candidate.

### Advantageous Effects of Invention

According to the present invention, it is possible to extract a trace of an attack with high accuracy.

### BRIEF DESCRIPTION OF DRAWINGS

FIG. 1 is a diagram for explaining an outline of an extraction device.

FIG. 2 is a diagram for explaining an outline of an extraction device.

FIG. 3 is a diagram illustrating a configuration example of an extraction device.

FIG. 4 is a diagram illustrating an example of a signature used in a rule of FIG. 3.

FIG. 5 is a diagram illustrating an example of the rule of FIG. 3.

FIG. 6 is a flowchart for describing an example of a processing procedure of an extraction device.

FIG. 7 is a diagram illustrating an example of a computer which executes an extraction program.

### DESCRIPTION OF EMBODIMENTS

Modes (embodiments) for carrying out the present invention will be described below with reference to the drawings. The invention is not limited to the embodiments described below.

### Overview

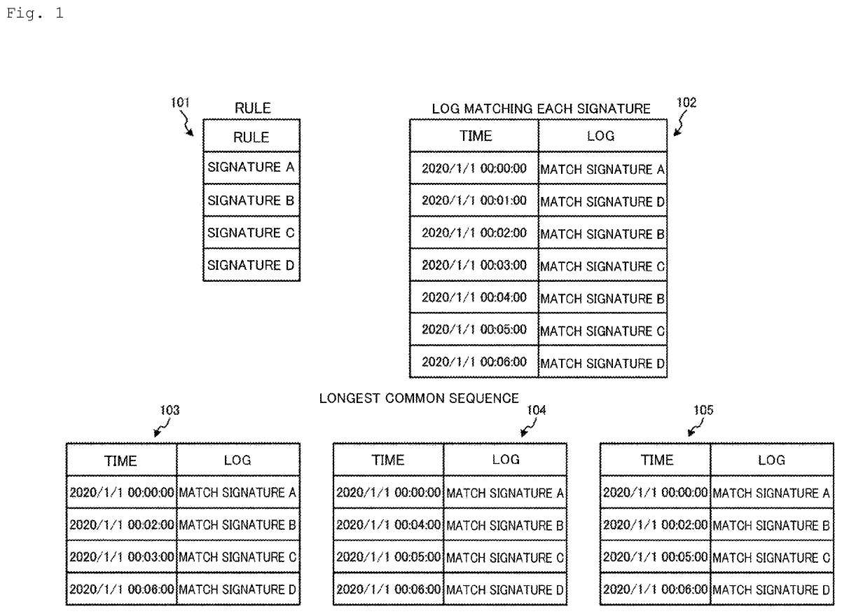

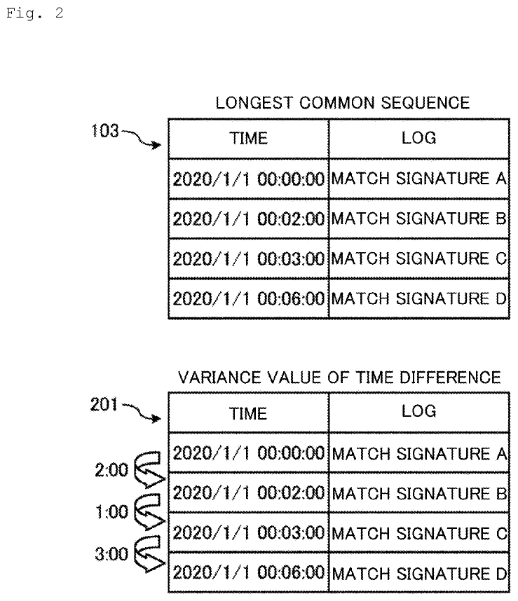

First, an outline of an extraction device of an embodiment will be described with reference to FIGS. 1 and 2. First, the extraction device prepares in advance a rule (refer to reference numeral 101 in FIG. 1) in which a plurality of signatures indicating attacks on a computer are arranged in an order characteristic of the attacks.

Subsequently, the extraction device arranges log groups of the computer to be investigated in a chronological sequence and extracts a log group (refer to reference numeral 102) which matches each signature indicated in the rule. Subsequently, the extraction device extracts a log group in which the longest common subsequence between a sequence of signatures matching the logs of the extracted log group and a sequence of signatures indicated in the rule is the longest (refer to reference numerals 103 to 105).

Here, as indicated by reference numerals 103 to 105 in FIG. 1, when there are a plurality of log groups in which the longest common subsequence with the sequence of signatures indicated in the rule is the longest, the extraction device calculates, for each of the log groups, a variance value of a time difference between each log which is chronologically adjacent in the log group.

For example, when the log group in which the longest common subsequence with the sequence of signatures indicated in the rule is the longest is the log group indicated by reference numeral 103 in FIG. 2, in the extraction device, time differences between adjacent logs in chronological sequence are “2:00, 1:00, and 3:00” (refer to reference numeral 201). Therefore, the extraction device calculates variance values of “2:00, 1:00, and 3:00”. For example, the extraction device converts “2:00, 1:00, and 3:00” in units of seconds and calculates the variance values of the values converted in units of seconds (“120, 60, and 180”).

The extraction device also calculates the above-described variance value for other log groups in which the longest common subsequence with the sequence of signatures indicated in the rule is the longest and outputs the longest common subsequence in the log group with the smallest variance value as an attack candidate. For example, when the log group indicated by reference numeral 103 among the log groups indicated by reference numerals 103 to 105 in FIG. 1 has the smallest variance value, the extraction device outputs the longest common subsequence (matching signature A→matching signature B→matching signature C→matching signature D) in the log group as an attack trace candidate.

According to such an extraction device, a series of attacks in which the longest common subsequence with a series of signatures indicated in the rule is the longest can be extracted as attack candidates from the log of the computer to be investigated. Thus, the extraction device can accurately extract candidates for traces of attacks from the log of the computer to be investigated.

### Configuration Example

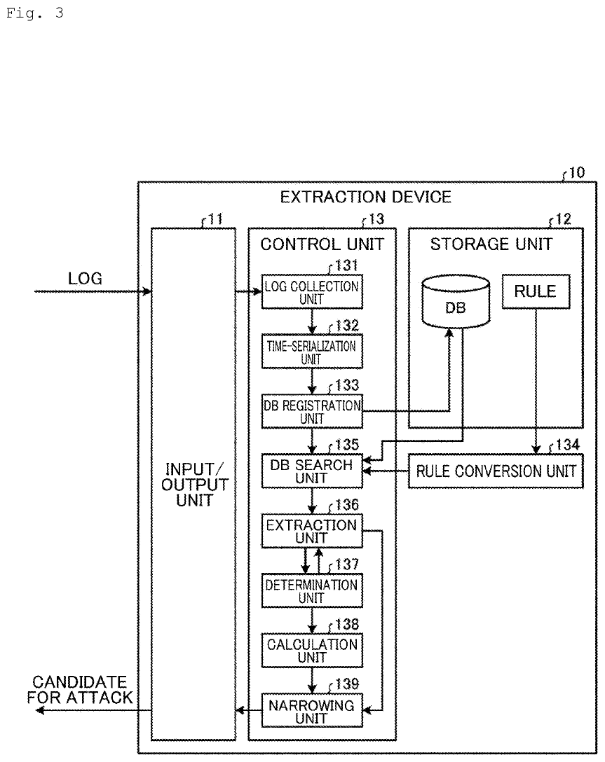

A configuration example of an extraction device 10 will be described below with reference to FIG. 3. The extraction device 10 includes an input/output unit 11, a storage unit 12, and a control unit 13.

The input/output unit 11 is an interface configured to control input/output of various data. For example, the input/output unit 11 receives an input of a log of a computer to be investigated and outputs candidates for traces of attacks.

The storage unit 12 stores rules. This rule is obtained by arranging a plurality of signatures indicating an attack on a computer in an order characteristic of the attack (refer to reference numeral 101 in FIG. 1).

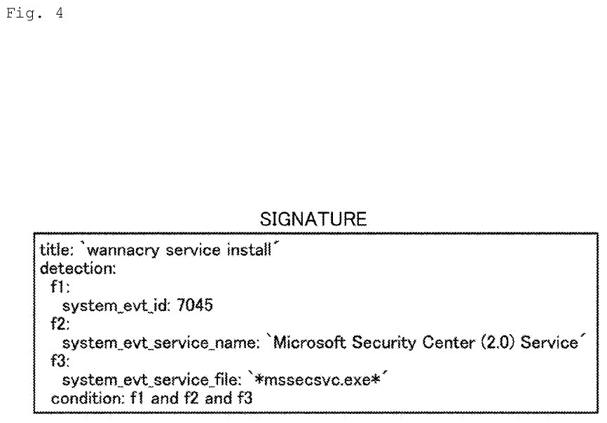

A signature is a characteristic of a log recorded by a computer when the computer is attacked. For example, the signature describes a behavior of malware on the computer (refer to FIG. 4).

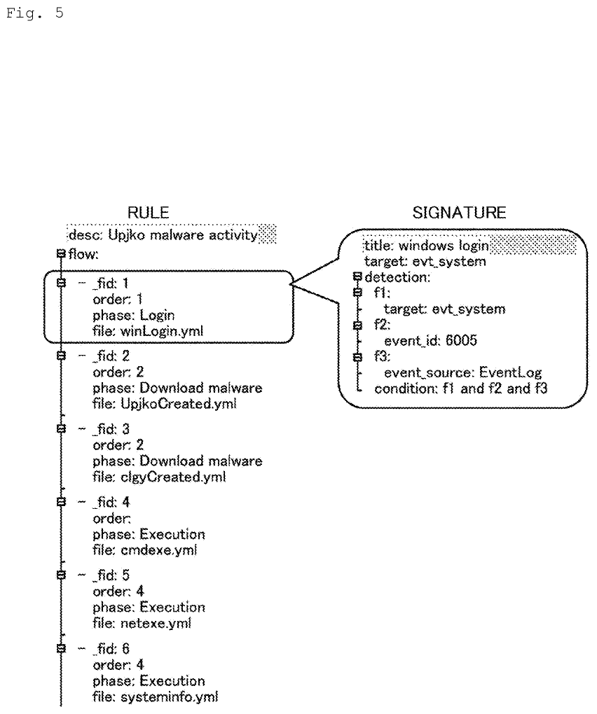

The rule is described by, for example, assigning a value which indicates the order characteristic of an attack to each signature, as shown in FIG. 5. Here, the values indicating the order assigned to each signature may have the same value. In addition, there may be signatures to which the value indicating the order is not assigned among the signatures.

The description provided with reference to FIG. 3 again will be provided. Furthermore, the storage unit 12 includes a DB. The DB stores logs registered by the DB registration unit 133 (logs of computers to be investigated arranged in a chronological sequence).

The control unit 13 controls the extraction device 10 as a whole. The control unit 13 includes a log collection unit 131, a time-serialization unit 132, a DB registration unit 133, a rule conversion unit 134, a DB search unit (first extraction unit) 135, and an extraction unit (second extraction unit) 136, a determination unit 137, a calculation unit 138, and a narrowing unit (output processing unit) 139.

The log collection unit 131 collects logs from a computer to be investigated. For example, the log collection unit 131 collects event logs, registries, file operation histories, and the like from the computer to be investigated. For example, the log collection unit 131 collects the above-described logs using a cyber defense institute incident response collector (CDIR-C) or the like.

The time-serialization unit 132 re-arranges the logs collected by the log collection unit 131 in a chronological sequence. The DB registration unit 133 registers the logs chronologically re-arranged by the time-serialization unit 132 in the DB.

The rule conversion unit 134 converts the signature described in the rule into a search query for searching for logs which match the signature. The DB search unit 135 uses the search query converted by the rule conversion unit 134 to search for logs in the DB. That is to say, the DB search unit 135 extracts, from the DB, a log group which matches the signature indicated by the rule. For example, the DB search unit 135 extracts, from the DB, a log group which matches each signature indicated by reference numeral 101 in FIG. 1 (refer to reference numeral 102 in FIG. 1).

The description provided with reference to FIG. 3 again will be provided. The extraction unit 136 extracts, from the log group found by the DB search unit 135, the log group in which the longest common subsequence with the sequence of signatures indicated in the rule is the longest on the basis of the chronological sequence of the signatures in which each log in the log group matches. For example, the extraction unit 136 extracts a log group in which the longest partial character string with the sequence of signatures indicated by reference numeral 101 in FIG. 1 is the longest from the log group indicated by reference numeral 102 in FIG. 1 (refer to reference numerals 103 to 105 in FIG. 1).

The description provided with reference to FIG. 3 will be returned to. The determination unit 137 determines whether there are a plurality of log groups in which the longest common subsequence extracted by the extraction unit 136 is the longest. When the determination unit 137 determines that there are multiple log groups in which the longest common subsequence is the longest, the calculation unit 138 calculates, for each log group in which the longest common subsequence is the longest, the variance value of the time difference between adjacent logs in time series in the log group.

For example, the calculation unit 138 calculates, for the log group in which the longest common subsequence indicated by reference numeral 103 in FIG. 2 is the longest, the variance value of the time difference between adjacent logs in chronological sequence (refer to reference numeral 201 in FIG. 2). Also, the calculation unit 138 similarly calculates the variance value of the time differences between adjacent logs in time series in the log group indicated by reference numerals 104 and 105 in FIG. 1.

The description provided with reference to FIG. 3 again will be provided. The narrowing unit 139 narrows down the candidates for traces of attack. For example, the narrowing unit 139 outputs the longest common subsequence in the log group in which the variance value calculated by the calculation unit 138 is the smallest among the log groups in which the longest common subsequence is the longest extracted by the extraction unit 136, as an attack trace candidate (attack candidate).

Note that when there is only one log group in which the longest common subsequence is the longest extracted by the extraction unit 136, the narrowing unit 139 outputs the longest common subsequence in the log group extracted by the extraction unit 136 as an attack candidate. According to the extraction device 10 described above, attack candidates can be extracted with high accuracy.

### Example of Processing Procedure

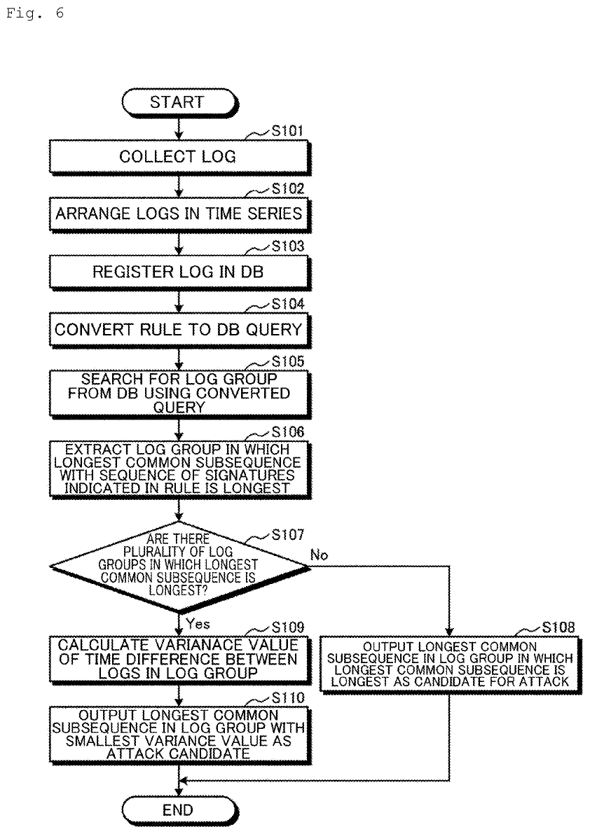

Subsequently, an example of a processing procedure of the extraction device 10 will be described with reference to FIG. 6. First, the log collection unit 131 collects logs to be processed from the computer to be investigated via the input/output unit 11 (S101). Subsequently, the time-serialization unit 132 arranges the logs collected in S101 in time series (S102). Furthermore, the DB registration unit 133 registers the logs re-arranged in S102 in the DB (S103).

Also, the rule conversion unit 134 reads out the rule in the storage unit 12 and converts the rule into a DB query (S104). Furthermore, the DB search unit 135 extracts a log group from the DB using the query converted in S104 (S105). That is, the DB search unit 135 extracts, from the DB, a log group which matches the signature indicated by the rule.

After S105, the extraction unit 136 extracts, from the log group extracted in S105, the log group in which the longest common subsequence between the sequence of signatures corresponding to the logs constituting the log group and the sequence of signatures indicated in the rule is the longest (S106).

After S106, the determination unit 137 determines whether there are a plurality of log groups in which the longest common subsequence is the longest extracted in S106 (S107) and outputs the longest common subsequence in the log group extracted in S106 as an attack candidate (S108) when there is not more than one (No in S107).

On the other hand, in S107, when the determination unit 137 determines that there are a plurality of log groups in which the longest common subsequence is the longest extracted in S106 (Yes in S107), the calculation unit 138 calculates, for each of the log groups extracted in S106, the variance value of the time difference between the logs in the log group (S109). Furthermore, the narrowing unit 139 outputs, as an attack candidate, the longest common subsequence in the log group with the minimum variance value calculated in S109 among the log groups extracted in S106 (S110). Thus, the extraction device 10 can accurately extract attack candidates.

### Other Embodiments

Note that, although the narrowing unit 139 outputs, as an attack candidate, the longest common subsequence in the log group in which the longest common subsequence with the sequence of signatures indicated in the rule is the longest, the present invention is not limited thereto. For example, the narrowing unit 139 may output not only the above longest common subsequence but also a log group (including time information of each log) in which the longest common subsequence is the longest as an attack candidate. Thus, a user of the extraction device 10 can analyze the content of the attack candidate in more detail.

Also, in the embodiment described above, the extraction device 10 arranges, but is not limited thereto, the logs acquired from the computer in a chronological sequence, and then extracts the log group in which the longest common subsequence with the sequence of signatures indicated in the rule is the longest.

For example, the extraction device 10 extracts a group of logs that match one of the signatures indicated by the rules from among the logs acquired from the computer, and then re-arranges them in chronological sequence. Moreover, the extraction device 10 may extract a log group in which the longest common subsequence between the sequence of signatures matching the logs re-arranged in a chronological sequence and the sequence of signatures indicated by the rule is the longest.

### [System Configuration and Like]

Also, each component of each part illustrated is functionally conceptual and does not necessarily need to be physically configured as illustrated. That is to say, the specific form of distribution and integration of each device is not limited to the illustrated one and all or a part of these can be functionally or physically distributed and integrated in arbitrary units in accordance with various loads and usage conditions. Furthermore, all or any part of each processing function performed by each device may be realized by a CPU and a program executed by the CPU or may be realized as hardware by a wired logic.

Also, among the processes described in the above embodiments, all or a part of the processes described as being performed automatically can be performed manually or all or a part of the processes described as being performed manually can be performed automatically by known methods. In addition, information including processing procedures, control procedures, specific names, and various data and parameters shown in the above documents and drawings can be arbitrarily changed unless otherwise specified.

### [Program]

The extraction device 10 described above can be implemented by installing a program on a desired computer as package software or online software. For example, the information processing device can function as the extraction device 10 by causing the information processing device to execute the above program. The information processing device referred to as herein includes a desktop or a notebook personal computer. Furthermore, information processing devices include mobile communication terminals such as smartphones, mobile phones and personal handyphone systems (PHSs), and terminals such as personal digital assistants (PDAs).

Furthermore, the extraction device 10 can also be implemented as a server device which uses a terminal device used by a user as a client and provides the client with services related to the above processing. In this case, the server device may be implemented as a web server or may be implemented as a cloud that provides services relating to the above processing through outsourcing.

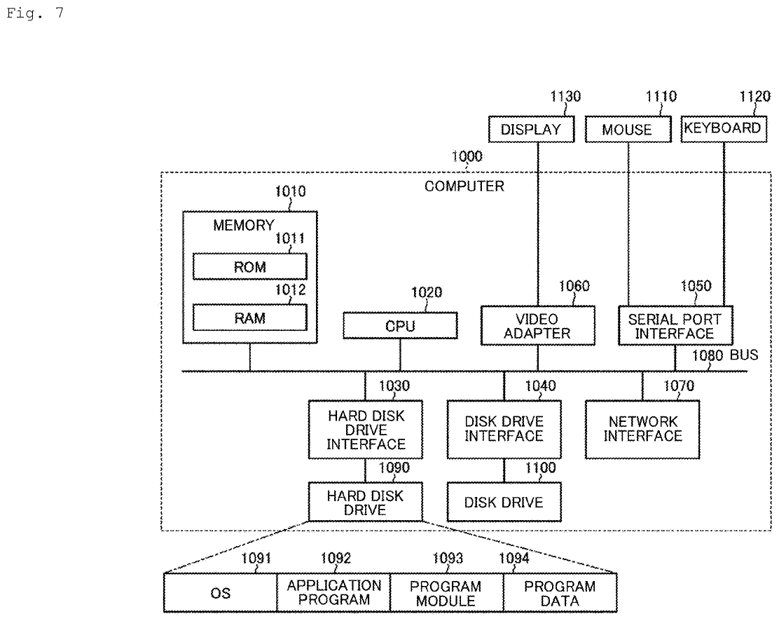

FIG. 7 is a diagram illustrating an example of a computer which executes an extraction program. A computer 1000 has, for example, a memory 1010 and a CPU 1020. Furthermore, the computer 1000 has a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to the hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, application programs 1092, program modules 1093, and program data 1094. That is to say, a program in which each process executed by the extraction device 10 is defined is implemented as a program module 1093 in which computer-executable code is described. The program module 1093 is stored, for example, on the hard disk drive 1090. For example, the hard disk drive 1090 stores the program module 1093 for executing processing similar to the functional constitution of the extraction device 10. Note that the hard disk drive 1090 may be replaced by a solid state drive (SSD).

Furthermore, data used in the processing of the above-described embodiments are stored, for example, as program data 1094 in the memory 1010 or the hard disk drive 1090. In addition, the CPU 1020 reads the program module 1093 and the program data 1094 stored in the memory 1010 and the hard disk drive 1090 to the RAM 1012 and executes them as necessary.

Note that the program module 1093 and the program data 1094 are not limited to being stored in the hard disk drive 1090, but may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). In addition, the program module 1093 and the program data 1094 may be read by the CPU 1020 from the other computer via the network interface 1070.

### REFERENCE SIGNS LIST

10 Extraction device
11 Input/output unit
12 Storage unit
13 Control unit
131 Log collection unit
132 Time-serialization unit
133 DB registration unit
134 Rule conversion unit
135 DB search unit
136 Extraction unit
137 Determination unit
138 Calculation unit
139 Narrowing unit

1. An extraction device comprising a processor configured to execute operations comprising:
collecting a log of a computer to be investigated;
extracting a first log group which matches a signature indicated by a rule from the collected logs, wherein the rule includes an ordered list of a plurality of signatures that indicate an attack on the computer, and the ordered list includes the plurality of signatures in order of characteristic of the attack;
extracting a second log group in which a longest common subsequence between a chronological sequence of signatures which match logs in the extracted first log group and a sequence of a plurality of signatures indicated in the rule is the longest;
calculating, for each log group in which the longest common subsequence is the longest, a variance value of a time difference between each log which is adjacent in time series in said each log group; and
outputting the longest common subsequence in a third log group with a minimum calculated variance value as an attack trace candidate.

2. The extraction device according to claim 1, wherein the longest common subsequence represents
a length of a longest common subsequence between a sequence of signatures when the log group matching any of the signatures indicated in the rule is re-arranged in a chronological sequence and a sequence of a plurality of signatures indicated in the rule.

3. The extraction device according to claim 1, the processor further configured to execute operations comprising:
determining whether there is a plurality of log groups in which the longest common subsequence is the longest,
wherein, when the determination indicates that there is a plurality of log groups in which the longest common subsequence is the longest, the calculating further comprises calculating, for each log group in which the longest common subsequence is the longest, a variance value of time differences between adjacent logs in time series in the log group.

4. The extraction device according to claim 3, wherein, when the determination indicates that there is not a plurality of log groups in which the longest common subsequence is the longest,
the outputting further comprises outputting the longest common subsequence in the log group in which the longest common subsequence is the longest as an attack trace candidate.

5. The extraction device according to claim 1, wherein the outputting further comprises outputting a log group in which the calculated variance value is the smallest.

6. An extraction method comprising:
a step of collecting a log of a computer to be investigated;
a step of referring to a rule in which a plurality of signatures indicating an attack on the computer are arranged in an order characteristic of the attack and extracting, from the collected logs, a first log group matching any signature indicated in the rule;
a step of extracting a second log group in which a longest common subsequence between a chronological sequence of signatures matched by each log in the extracted first log group and a sequence of a plurality of signatures indicated by the rule is the longest;
a step of calculating, for each of the log groups in which the longest common subsequence is the longest, a variance value of a time difference between adjacent logs in said each log group in a chronological sequence; and
a step of outputting the longest common subsequence in a third log group with the smallest calculated variance value as a candidate for the trace of an attack.

7. A computer-readable non-transitory recording medium storing computer-executable program instructions that when executed by a processor cause a computer to execute operations comprising:
a step of collecting a log of a computer to be investigated;
a step of referring to a rule in which a plurality of signatures indicating an attack on the computer are arranged in an order characteristic of the attack and extracting, from the collected logs, a first log group matching any signature indicated in the rule;
a step of extracting a second log group in which a longest common subsequence between a chronological sequence of signatures matched by each log in the extracted first log group and a sequence of a plurality of signatures indicated by the rule is the longest;
a step of calculating, for each of the log groups in which the longest common subsequence is the longest, a variance value of a time difference between adjacent logs in said each log group in a chronological sequence; and
a step of outputting the longest common subsequence in a third log group with the smallest calculated variance value as a candidate for the trace of the attack.

8. The extraction method according to claim 6, wherein the longest common subsequence represents
a length of a longest common subsequence between a sequence of signatures when the log group matching any of the signatures indicated in the rule is re-arranged in a chronological sequence and a sequence of a plurality of signatures indicated in the rule.

9. The extraction method according to claim 6, further comprising:
determining whether there is a plurality of log groups in which the longest common subsequence is the longest,
wherein, when the determination indicates that there is a plurality of log groups in which the longest common subsequence is the longest, the calculating further comprises calculating, for each log group in which the longest common subsequence is the longest, a variance value of time differences between adjacent logs in time series in the log group.

10. The extraction method according to claim 9,
wherein, when the determination indicates that there is not a plurality of log groups in which the longest common subsequence is the longest,
the outputting further comprises outputting the longest common subsequence in the log group in which the longest common subsequence is the longest as an attack trace candidate.

11. The extraction method according to claim 6, wherein the outputting further comprises outputting a log group in which the calculated variance value is the smallest.

12. The computer-readable non-transitory recording medium according to claim 7, wherein the longest common subsequence represents
a length of a longest common subsequence between a sequence of signatures when the log group matching any of the signatures indicated in the rule is re-arranged in a chronological sequence and a sequence of a plurality of signatures indicated in the rule.

13. The computer-readable non-transitory recording medium according to claim 7, the computer-executable program instructions when executed further causing the computer system to execute operations comprising:
determining whether there is a plurality of log groups in which the longest common subsequence is the longest,
wherein, when the determination indicates that there is a plurality of log groups in which the longest common subsequence is the longest, the calculating further comprises calculating, for each log group in which the longest common subsequence is the longest, a variance value of time differences between adjacent logs in time series in the log group.

14. The computer-readable non-transitory recording medium according to claim 13, wherein, when the determination indicates that there is not a plurality of log groups in which the longest common subsequence is the longest,
the outputting further comprises outputting the longest common subsequence in the log group in which the longest common subsequence is the longest as an attack trace candidate.

15. The computer-readable non-transitory recording medium according to claim 7, wherein the outputting further comprises outputting a log group in which the calculated variance value is the smallest.
